(19) United States
(12) Patent Application Publication
(10) Pub. No.: US 2008/0060530 A1
(43) Pub. Date: Mar. 13, 2008

(54) Silicone bakeware

(75) Inventors: Joel Tetreault, Haskins, OH (US); Paul Angelo LoGiudice, Toledo, OH (US)

Correspondence Address: FOLEY AND LARDNER LLP;SUITE 500, 3000 K STREET NW, WASHINGTON, DC, 20007, US

(73) Assignee: Calphalon Corporation

(21) Appl. No.: 11/518,948

(22) Filed: Sep. 12, 2006

(51) Int. Cl. A47J 37/01; A21B 3/13

(52) U.S. Cl. 99/355; 264/299; 99/324

(57) ABSTRACT

The disclosed bakeware for food products provides flexibility for de-molding a food product while providing sufficient rigidity for various baking uses. The bakeware can comprise one or more flexible receptacles for receiving food products in which the one or more receptacles have one or more side walls extending to a flexible rim portion and a plurality of handle portions attached to the flexible rim portion. Each handle portion can include at least one rigid insert adapted to maintain the shape of the bakeware.

### BACKGROUND

The present invention relates to silicone bakeware, and more particularly, silicone bakeware with reinforcements in the handle portions.

Silicone bakeware involve containers that are quite flexible which allow food to be removed more easily than with traditional bakeware. In addition, the silicone composition of the bakeware prevents strong odors. A disadvantage to using silicone bakeware is that its flexibility can make it difficult to handle. For example, when the bakeware is picked up to be transferred from surface to surface, it tends to fold in on itself and spill its contents.

As seen in FIG. 1, a traditional silicone bakeware container 100 that comprises one set of parallel side walls 102 and 104 which have handles portions 112 and 114, respectively; another set of parallel side walls 106 and 108 that are perpendicular to the side walls 102 and 104; and a bottom floor 110. The four side walls and bottom floor are formed as one integrated piece. The handle portions 102 and 104 are also integral to their respective side walls. The entire structure of the container 100 is made from flexible silicone, and as a result the resulting container is not very rigid. FIG. 1 shows how a user 120 can easily bend the side walls 102 and 104 which results in dents 122 from merely pressing down on the handle portions 112 and 114. Furthermore, there is no rigidity when the container 100 is picked up, particularly when the container is full of a food product, such as batter. When the container 100 is picked up, the side walls 106 and 108 can easily collapse due to the weight of the food product inside the container because there is no structure in the silicone to provide any support.

To counteract this “flimsiness,” most users simply place a metal cooking sheet or other rigid pan underneath the bakeware to transfer the bakeware to and from the oven. This solution is inconvenient and undesirable because the additional cooking sheet may result in uneven baking of the food product contained in the bakeware.

There have been various attempts by manufacturers to solve the flimsiness problem. One contemplated solution was to include a steel ring that is molded around the perimeter of the container. Although rigidity of the container is improved, the flexibility for de-molding the food product was diminished.

Thus, there is a need for a silicone baking container that would allow for the easy transport of food products contained therein. In addition, there is a need to develop silicone bakeware that maintains the balance between flexibility and rigidity so there is flexibility where it is desired for de-molding the food product and rigidity where it is required for the prevention of the collapse of the container due to the weight of the food product.

### SUMMARY

The present invention can provide rigidity in key areas of the silicone bakeware through the use of rigid inserts inserted within the handle area of the container.

According to one embodiment of the present invention, bakeware for food products is disclosed, which comprises one or more flexible receptacles for receiving food products in which the one or more receptacles have one or more side walls extending to a flexible rim portion and a plurality of handle portions attached to the flexible rim portion. Each handle portion can include at least one rigid insert adapted to maintain the shape of the bakeware. In addition, the one or more receptacles and the handle portions may be formed from silicone.

The at least one rigid insert can be formed from a metal (for example low carbon steel), a high temperature plastic, or a high temperature polymer. The rigid insert can be encapsulated by their respective handle portions or can be at least partially exposed by the silicone. In one embodiment, an edge of the at least one rigid insert terminates at a portion of the flexible rim portion where the handle portion is attached. Also, each rigid insert may be substantially the same shape as their respective handle portions, may have a plurality of rib elements, and/or have sufficient elasticity to facilitate the release of food products from the one or more receptacles.

In another embodiment of the present invention, a method of making silicone bakeware for food products is disclosed that can comprise providing upper and lower molds. The upper and lower molds can form a cavity that will form the bakeware with one or more receptacles having one or more side walls extending from a rim portion and a plurality of handle portions attached to the rim portion. The method can also include the steps of providing a rigid insert in each portion of the cavity in which the handle portions are to be formed by placing the rigid inserts on locator pins that protrude into the cavity and injecting silicone into the cavity.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and accompanying exemplary embodiments shown in the drawings, which are briefly described below.

FIG. 1 shows a perspective view illustrating silicone bakeware of the prior art.

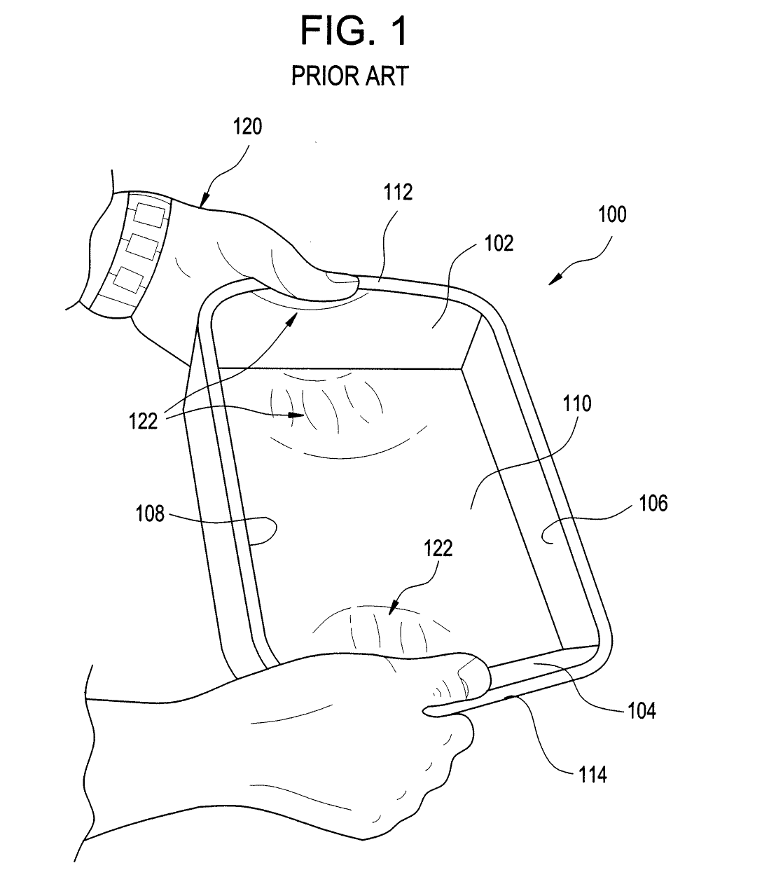

FIGS. 2(a)-(c) show a perspective view illustrating silicone bakeware according to various embodiments of the present invention.

FIGS. 3(a)-(e) show silicone bakeware in the form of a cake pan according to an embodiment of the present invention.

FIG. 4 shows the configuration of the rigid insert that can be used in the cake pan of FIGS. 3(a)-3(e).

FIG. 5 shows the upper and lower molds used to make the silicone bakeware according to an embodiment of the present invention.

FIG. 6 shows the assembly of the upper and lower molds during the manufacturing process according to an embodiment of the present invention.

### DETAILED DESCRIPTION

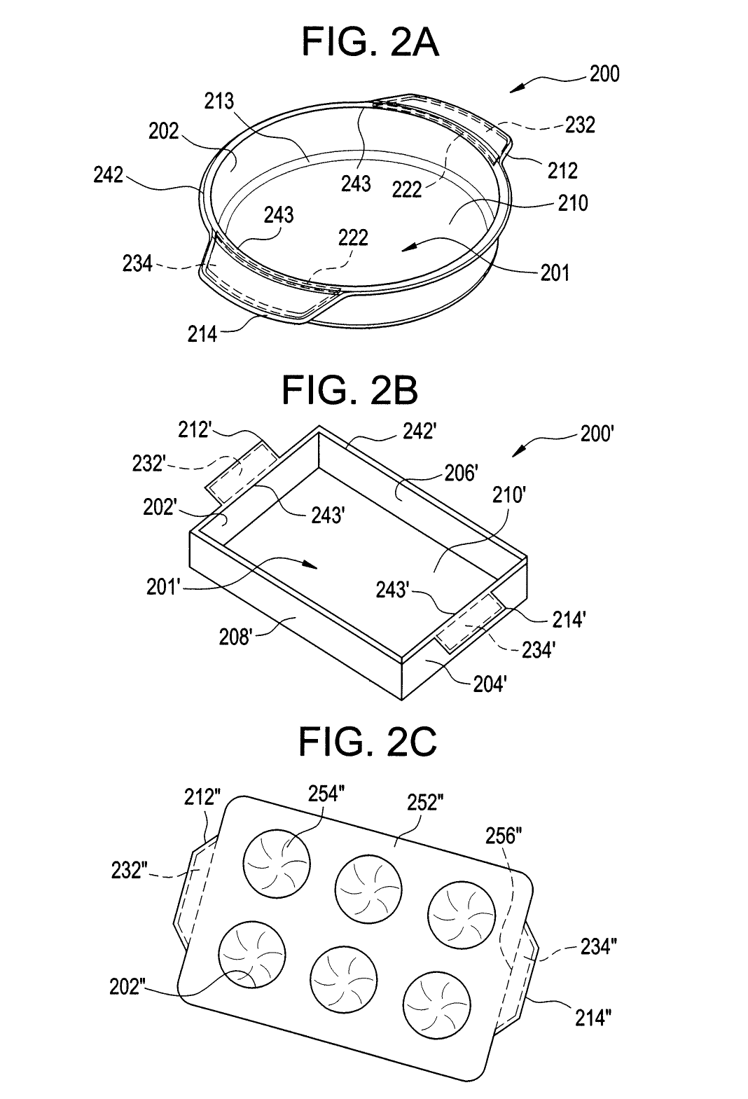

Embodiments of the present invention will now be described with reference to the drawings. FIGS. 2(a)-(c) disclose perspective views of the bakeware 200, 200′, and 200″ according to various embodiments of the present invention. The bakeware 200 can be made from flexible silicone, such as silicone of the methyl-vinyl-polysiloxane type as disclosed in U.S. Pat. No. 6,197,359 (incorporated by reference herein in its entirety) or the silicone elastomers disclosed in U.S. Patent Application Publication 2006-0093715 (incorporated by reference herein in its entirety). In one preferred embodiment, 100% FDA grade silicone with no fillers can be used.

The general structure of the flexible bakeware can take many forms. FIG. 2(a) depicts bakeware with one receptacle 201 for receiving food products. The receptacle 201 can be a generally cylindrical structure with a circumferential side wall 202 extending to a flexible rim portion 242 and a bottom floor 210. A first handle portion 212 with a rigid insert 232 (in dotted lines) and a second handle portion 214 with a rigid insert 234 (in dotted lines) are attached to the flexible rim portion 242. The bottom floor 210 is generally circular with the circumferential side wall 202 protruding substantially perpendicular from the plane of the bottom floor. There can also be a curved transition portion 213 that connects the bottom floor 210 with the side wall 202. The side wall extends to a rim portion 242 and the two handle portions 212 and 214 attach to the rim portion 242. Each handle portion can run substantially parallel to the bottom floor 210. In the example shown in FIG. 2(a), the handle portions form generally a semi-circle; however, the handle portions can be any suitable shape, such as square, rectangular, semi-circular, trapezoidal, or oval. In addition, the handle portions can be a uniform thickness but it is not required. For example, the portion of the handle portion nearer to the side walls of the receptacle can be thicker than the portion of the handle portion farther from the side wall. The handle portions 112 and 114, the circumferential wall 102, and the bottom floor 210 can be made from the same silicone material and be one integral piece.

The handle portions 112 and 114 both include rigid inserts 232 and 234, respectively. These inserts are used to provide the necessary rigidity to the bakeware so that the bakeware will not collapse under the weight of the food product located in the receptacle 201, i.e., the rigid inserts are adapted to maintain the shape of the bakeware. The flexibility of the bakeware is maintained because the rigid inserts are located substantially in the handle portions. Thus, the advantage of being able to easily de-mold food products can be maintained. In addition, the rigid inserts can be made to have a sufficient elasticity to facilitate the release of food products from the one or more receptacles.

The inserts can be made from any suitable material, such as metal, a high temperature plastic, or a high temperature polymer. Two suitable types of metal include stainless steel or low carbon steel. The inserts may be completely encapsulated by the handle portions 112 and 114 in the molding process that will be disclosed later. Alternatively, the rigid inserts may be entirely encapsulated by the silicone but the inner edges 222 of the rigid inserts terminate at portions 243 of the rim portion 242 where the handle portions 112 and 114 are attached. As shown in FIG. 2(a), the rigid inserts 232 and 234 may be similar in shape to the handle portions 112 and 114, i.e., the inserts can be shaped generally in a substantially semi-circular shape. However, the inserts are not limited to be similar in shape as the handle portions that encapsulate them. For example, the inserts 232 and 234 in FIG. 2(a) can be semi-circular, rectangular, oval, square, triangular, or any other conceivable shape.

In yet another embodiment, one or more rigid inserts may be at least partially exposed by the silicone after the manufacturing process. For example, a central portion of the rigid insert may be exposed after the manufacturing process.

In addition, the rigid inserts shown in FIG. 2(a) are generally planar with a uniform thickness but uniform thickness is not required. For example, the portion of the insert nearer to the side walls of the receptacle can be thicker than the portion of the insert farther from the side wall.

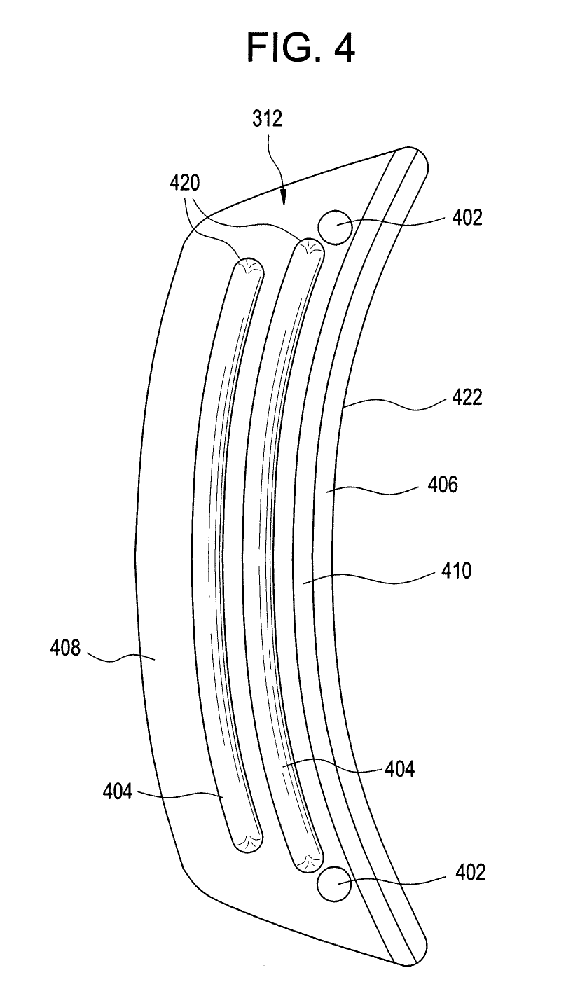

Although FIG. 2(a) shows a container 200 with a circular floor 210, the flexible bakeware is not limited to this shape. For example, FIG. 2(b) shows another suitable embodiment in the form of the flexible bakeware 200′. In FIG. 2(b), the general shape of the receptacle 201′ can be more of a cuboid shape with a rectangular or square floor 210′, a set of rectangular or square side walls 202′ and 204′, and a set of rectangular or square side walls 206′ and 208′. The side walls 202′, 204′, 206′, and 208′ extend to a flexible rim portion 242′. Also, there are handle portions 212′ and 214′, which are attached to the rim portion 242′. The handle portions 212′ and 214′ can be any suitable shape, for example rectangular as seen in FIG. 2(b). The side walls, bottom floor, and handle portions can be one integral piece made of silicone. The handle portions 212′ and 214′ have rigid inserts 232′ and 234′, respectively. The rigid inserts can be encapsulated in the silicone, either by being entirely encapsulated by the handle portions or by having the edges 422′ (see FIG. 4) of the rigid inserts terminate at portions 243′ of the rim portion 242′ where the handle portions 112′ and 114′ are attached. In addition, the rigid inserts can be any suitable shape, for example rectangular, as seen in FIG. 2(b).

Other overall shapes of the receptacle are also contemplated such as bakeware with a bottom floor that can be oval, trapezoidal, square, triangular, or any other suitable shape. In addition, the number, shape, and angular orientation of the side walls that protrude from the bottom floor can be varied according to the desired shape. Another example of a suitable bakeware shape is provided in FIG. 2(c) in which a pan 200″ for baking muffins is shown.

In FIG. 2(c), the flexible bakeware 200″ can comprise a plurality of receptacles 254″ for receiving food products, for example batter for making muffins. Each receptacle has a side wall 202″ extending to a flexible rim portion 252″, which in this case is in the form of an upper surface. There is a plurality of handle portions 212″ and 214″ which can be attached to the flexible rim portion 252″ near the surface portion 256″. Each handle portion can include a rigid insert 232″, 234″, which is used to maintain the shape of the bakeware. As in previous embodiments, the rigid inserts can be encapsulated into the handle portions or the edges of the rigid inserts can terminate at portions of the flexible rim portion where the handle portions are attached.

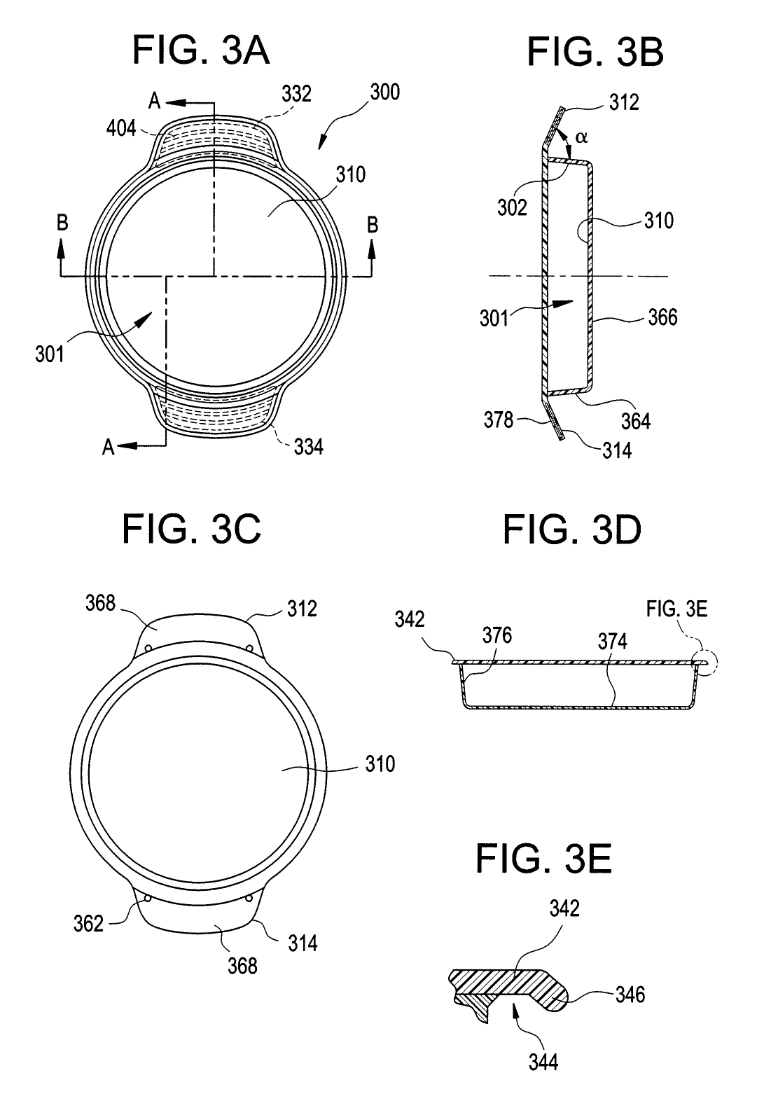

FIGS. 3(a)-3(e) show another example of the silicone bakeware 300 according to an embodiment of the present invention. FIG. 3(a) shows a top view of a nine inch round cake pan. FIG. 3(b) shows a cross-sectional view taken along line A-A in FIG. 3(a). FIG. 3(c) shows a bottom view of the cake pan. FIG. 3(d) shows a cross-sectional view taken along line B-B in FIG. 3(a). FIG. 3(e) shows a detail of the rim portion 342 as indicated in FIG. 3(d).

The cake pan 300 shown in FIGS. 3(a)-3(e) comprises a receptacle 301 with a circular bottom floor 310 and a circumferential side wall 302 projecting from the bottom floor 310. The side walls extend to a flexible rim portion 342 and handle portions 312 and 314 are attached to the rim portion 342. Each handle portion 312, 314 includes at least one rigid insert 332, 334 adapted to maintain the shape of the bakeware 300. As can be seen in FIG. 3(b), the handle portions 312 and 314 are not perpendicular to the side wall 302 but are at an angle α. The rigid inserts 332 and 334 (in dotted lines) are similar in shape to the shape of the handle portions 312 and 314.

The cake pan 300, i.e., the receptacle 301 (the bottom floor 310, the side wall 302, and rim portion 342) and the handle portions 312 and 314, can be made of a single type of silicone, such as 100% FDA grade silicone with no fillers. In addition, the various surfaces of the bakeware can have different finishes. For example, there can be a matte finish on the external portion 364 of the side wall 302, the external portion 366 of the bottom floor 310, and the bottom surfaces 368 of the handle portions 312 and 314. The internal portion 374 of the bottom floor 310 and the internal portion 376 of the side wall 302 can have a highly polished finish while the upper surfaces 378 of the handle portions 312 and 314 can have a textured finish for easier gripping.

The rim portion 342 of the cake pan 300 can be any suitable configuration, for example the configuration shown in FIG. 3(e) in which the rim portion 342 has a curved tip 346 that curves downward causing a groove 344.

FIG. 4 shows the configuration of the rigid insert 312 that can be used in the cake pan 300 of FIGS. 3(a)-3(e). The insert 312 in FIG. 4 is formed at an angle with one portion 406 substantially perpendicular to the side wall 302 (i.e., the flat portion of the insert), another portion 408 at an angle α from the side wall 302 (as seen in FIG. 3(b)) and a transition portion 410 that connects the portion 406 to the portion 408. The portions 406, 408, and 410 can all substantially be the same thickness or, alternatively, be different thicknesses.

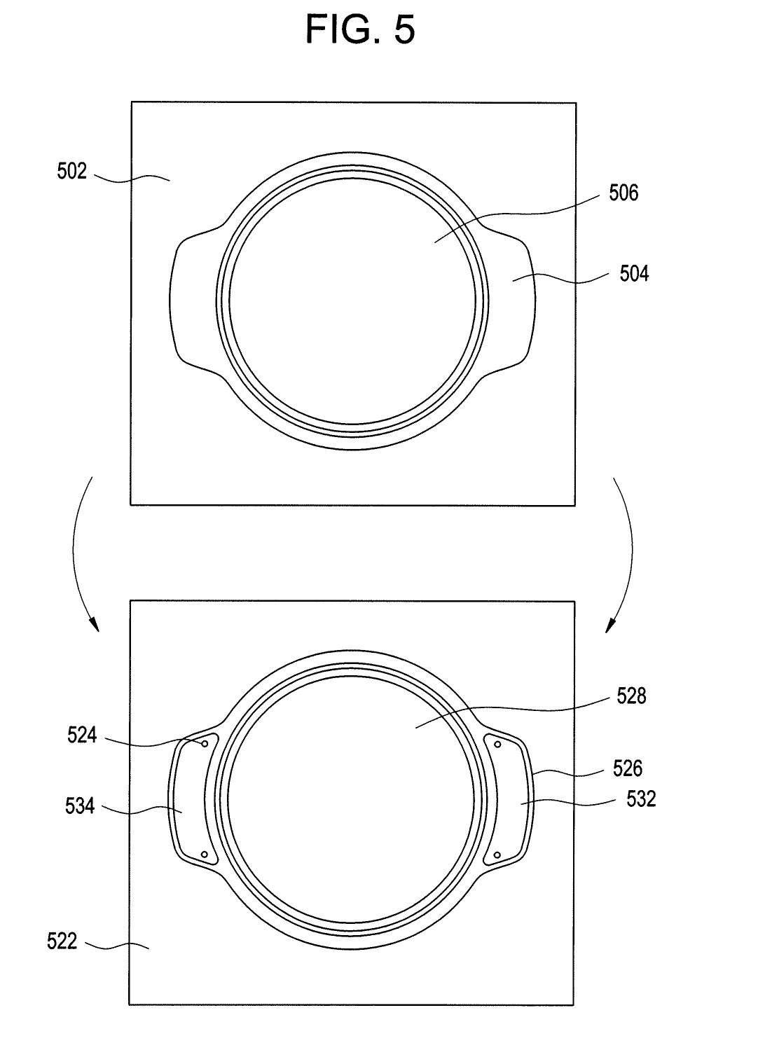

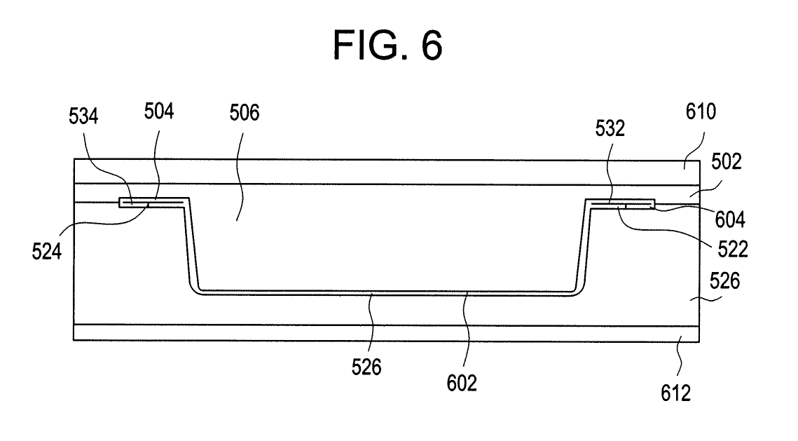

In addition, the rigid insert can made of a suitable material, such as low carbon steel, stainless steel, a high temperature polymer, or a high temperature plastic. The insert 312 can include one or more rib elements 404 and holes 402. The rib element 404 can take any form and are used to provide additional rigidity to the rigid insert. For example, FIG. 4 shows two rib elements that are curved in the same manner as the inner edge 422 of the rigid insert. In addition, the rib elements have rounded tips 420. The holes 402 are used to help facilitate the flow of silicone around the rigid insert during the manufacturing process, as will be described below with regards to FIGS. 5 and 6. It is noted, however, that the rib elements and/or the holes can be omitted from the insert, if desired.

The rigid inserts should be designed such that they maintain the shape of the bakeware. Thus, the inserts should have a size and thickness that would provide sufficient support to the receptacle so as to prevent the side walls and bottom floor of the receptacle from collapsing when the receptacle contains food products. In addition, the rigid inserts should have sufficient elasticity so as to facilitate the release of food products from the receptacle. In other words, the inserts should also have a size and thickness that would not diminish the flexibility of the bakeware which allows for the removal of the food product from the receptacle.

FIG. 5 shows the upper and lower molds used to make the flexible bakeware in a compression molding process according to an embodiment of the present invention. FIG. 6 shows the assembly of the upper and lower molds during the manufacturing process according to an embodiment of the present invention.

FIG. 5 shows an upper mold 502 with one or more recesses and/or protrusions 504 and 506, which are used to form the upper surfaces of the bakeware. In addition, there is a lower mold 522 which also includes one or more recesses and/or protrusions 526 and 528, which are used to form the bottom surfaces of the bakeware. The number and shape of the recess and the protrusions will depend upon the desired shape of the bakeware, for example the shapes shown in FIGS. 2(a)-2(c).

The upper mold 502 and the lower mold are provided such that the upper mold 502 will be placed in an opposing direction to the lower mold 522. The two molds will form a cavity 602, as seen in FIG. 6, in which the bakeware will be formed. The bakeware to be formed can have one or more receptacles having one or more side walls extending from a rim portion and a plurality of handle portions attached to the rim portion.

In the bottom mold, there is a series of locator pins 524 which supports the rigid insert 532 or 534. Although not shown, the pins 524 can fit inside small depressions on the underside of the inserts so that the inserts sit more securely on the pins. The locator pins (and later the rigid inserts 532 and 534) can be provided in the portions of the cavity 602 in which the handle portions are to be formed. The rigid inserts 532 and 534 sit on the locator pins 524 so that the inserts will be appropriately positioned in the handle portions 604 of the cavity 602 such that the inserts are suspended in the cavity as seen in FIG. 6.

In the compression molding process, the silicone is molded in the enclosed cavity formed by the upper mold 502 and the lower mold 522. Two platens 610 and 612 are provided to hold and heat the upper and lower molds in which the molds are between two heated platens 610 and 612. The silicone in semi-solid form is introduced into the mold in a partially cured condition. The silicone is injected into the mold just prior to molding. The platens 610 and 612, which hold the upper and lower molds 502 and 522, are heated. Pressure is exerted on the silicone material. The shearing action of the material being compressed together and the heat from the platens 610 and 612 cause the molding material to become soft. The soft plastic fills the cavity and is compressed by the pressure. The contributory strength of the temperature and the pressure accelerates the curing of the silicone in approximately four to ten minutes. The compression molding process can produce a heavy and dense product.

During the compression molding process, the rigid inserts 532 and 534 are placed on locator pins 524 so that the inserts are allowed to “float” in the center of the handle portion 604 of the cavity 602. When the silicone is introduced to the cavity 602, the plastic material also flows into the cavity 604 and around the rigid inserts. However, near the completion of the cycle time, the locator pins 524 are removed, or retracted, and the silicone flows over the area to partially or entirely enclose or encapsulate the inserts 532 and 534 in their respective handle portions. The locator pins do not necessarily have to be completely retracted out of the cavity 602. In such an instance, depressions 362 would be formed on the bottom side of the bakeware, as seen in FIG. 3(c).

In another embodiment of the present invention, the locator pins 524 may not be retracted at all during the forming process, which results in the one or more rigid inserts being partially exposed by the silicone after the manufacturing process.

The disclosed bakeware product provides a rigid insert that can be entirely or substantially enclosed or encapsulated within the handle portions. Because the rigid inserts are substantially contained in the handle portions, the flexibility of the silicone bakeware can be maintained while providing a more rigid structure that will not collapse under the weight of the material contained therein. Thus, the rigid inserts are adapted to allow the bakeware to maintain its shape.

It is also noted that other embodiments of the present invention are contemplated. For example, although the figures show bakeware with only two handle portions, any number of handle portions can be used, for example three, four, or more handle portions. Also, although the figures show bakeware with either four side walls or one circumferential wall, any number of sidewalls can be used to form the receptacle, such as three, five, or more sidewalls.

Given the disclosure of the present invention, one versed in the art would appreciate that there may be other embodiments and modifications within the scope and sprit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. Bakeware for food products comprising:
one or more flexible receptacles for receiving food products, wherein the one or more receptacles have one or more side walls extending to a flexible rim portion; and
a plurality of handle portions attached to the flexible rim portion,
wherein each handle portion includes at least one rigid insert adapted to maintain the shape of the bakeware, and
wherein the one or more receptacles and the handle portions are formed from silicone.

2. The bakeware for food products according to claim 1, wherein the at least one rigid insert is formed from a metal, a high temperature plastic, or a high temperature polymer.

3. The bakeware for food products according to claim 2, wherein the at least one rigid insert comprises low carbon steel.

4. The bakeware for food products according to claim 1, wherein the at least one rigid insert is encapsulated by their respective handle portions.

5. The bakeware for food products according to claim 1, wherein an edge of the at least one rigid insert terminates at a portion of the flexible rim portion where the handle portion is attached.

6. The bakeware for food products according to claim 1, wherein each rigid insert is substantially the same shape as their respective handle portions.

7. The bakeware for food products according to claim 1, wherein each rigid insert has a plurality of rib elements.

8. The bakeware for food products according to claim 1, wherein the rigid inserts have sufficient elasticity to facilitate release of food products from the one or more receptacles.

9. The bakeware for food products according to claim 1, wherein the at least one rigid insert is at least partially exposed by the silicone.

10. A method of making silicone bakeware for food products comprising:
providing upper and lower molds, wherein the upper and lower molds form a cavity that will form the bakeware with one or more receptacles having one or more side walls extending from a rim portion and a plurality of handle portions attached to the rim portion;
providing a rigid insert in each portion of the cavity in which the handle portions are to be formed by placing the rigid inserts on locator pins that protrude into the cavity; and
injecting silicone into the cavity.

11. The method of claim 10, wherein two platens are provided to hold and heat the upper and lower molds.

12. The method of claim 10, wherein near completion of the injection of the silicone into the cavity, the locator pins are removed or retracted such that the silicone flows over the inserts so as to enclose the metal inserts in the silicone.
